(19) United States
(12) Patent Application Publication
(10) Pub. No.: US 2024/0385667 A1
(43) Pub. Date: Nov. 21, 2024

(54) In-Vehicle Consumer Device Charging Network

(71) Applicant: AyDeeKay LLC dba Indie Semiconductor, Aliso Viejo, CA (US)

(72) Inventors: Robert Martin Voto, Clarkson, MI (US); Shyambabu Yeda, Rochester Hills, MI (US); Chenpeng Mu, Troy, MI (US)

(73) Assignee: AyDeeKay LLC dba Indie Semiconductor, Aliso Viejo, CA (US)

(21) Appl. No.: 18/667,337

(22) Filed: May 17, 2024

Related U.S. Application Data
(60) Provisional application No. 63/467,387, filed on May 18, 2023.

(51) Int. Cl. G06F 1/26

(52) U.S. Cl. CPC G06F 1/266

(57) ABSTRACT

An integrated circuit that dynamically adapts power to be provided by at least a first node in network is described. This integrated circuit may include a control circuit (or control logic) that performs the operations of: receiving charging information associated with one or more nodes in the network; determining, based at least in part on the charging information, a dynamic power to be supplied to an electronic device by at least the first node in the one or more nodes; and providing, addressed to at least the first node, an instruction specifying or indicating the dynamic power of at least the first node at a given time.

### CROSS REFERENCE TO RELATED APPLICATIONS

This application claims priority under 35 U.S.C. 119 (e) to U.S. Provisional Application Ser. No. 63/467,387, entitled “In-Vehicle Consumer Device Charging Network,” by Robert Martin Voto, et al., filed on May 18, 2024, the contents of which are herein incorporated by reference.

### FIELD

The present disclosure relates to techniques for dynamically adjusting power on nodes in a bus or a network.

### BACKGROUND

In order to provide improved connectivity and power distribution options, many automotive manufacturers are including additional sensors and/or features in their vehicles. For example, self-driving cars typically include a wide variety of sensors, such as acoustic and/or electromagnetic sensors that monitor the surrounding environment to detect other vehicles, people, animals, or obstacles. Moreover, many vehicles include sensors that monitor the operation of the vehicles (such as parking sensors or seat-adjustment sensors) and, more generally, components that provide features or functionality (such as internal lighting). Additionally, vehicles are starting to include more ports, such as Universal Serial Bus (USB) ports, to enable passengers to charge their electronic devices and/or connect their electronic devices to the vehicle's multimedia system.

Each of these sensors and components may include one or more integrated circuits and connecting each to a vehicle is often challenging. Notably, the sensors and components in existing vehicles are often at disparate locations. Furthermore, the sensors and components in existing vehicles are often electrically connected using separate wiring. However, as the number of sensors and components continues to increase, the wiring is becoming increasingly complicated, expensive and cumbersome to install and maintain.

### SUMMARY

In a first group of embodiments, an integrated circuit are described. This integrated circuit includes: an interface circuit that communicates with one or more nodes in a network of a vehicle. Moreover, the integrated circuit includes a control circuit (or control logic or a processor) that performs the operations of: receiving charging information associated with the one or more nodes; determining, based at least in part on the charging information, a dynamic power to be supplied to an electronic device by at least a first node in the one or more nodes; and providing, addressed to at least the first node, an instruction specifying or indicating the dynamic power of at least the first node at a given time.

Note that the network may include a bus. For example, the bus may include: a Local Interconnected Network (LIN) bus; a Universal Serial Bus (USB); a Control Area Network (CAN) bus; an Ethernet bus; or a wireless bus (such as a bus in which the one or more nodes communicate using a wireless communication protocol, such as Bluetooth or a communication protocol that is compatible with an Institute of Electrical and Electronics Engineers or IEEE 802.11 standard, e.g., IEEE 802.11ax, IEEE 802.11be or IEEE 802.11bn).

Moreover, the electronic device may be electrically coupled to the first node through a wired connection. Alternatively, in some embodiments, the electronic device is wirelessly coupled to the first node.

Furthermore, the one or more nodes may include charging devices.

Additionally, the one or more nodes may include multiple nodes, and the integrated circuit may be included in a second node in the multiple nodes. Alternatively, the integrated circuit may be separate from the one or more nodes. For example, the integrated circuit may include a controller for the one or more nodes. Note that the integrated circuit may include: a USB hub; or a head unit for the network.

In some embodiments, the one or more nodes may include multiple nodes, the instruction indicates that at least the first node is to supply a different power from at least a second node in the multiple nodes.

Moreover, the charging information may indicate: an identifier of the electronic device; or a type of the electronic device.

Furthermore, the instruction may indicate a maximum power supplied by at least the first node. Note that the integrated circuit may be used in a vehicle, and the maximum power may be different from a maximum power available in the vehicle.

Additionally, the one or more nodes may include multiple nodes, and the dynamic power may be determined based at least in part on power supplied by the multiple nodes.

In some embodiments, the dynamic power may be determined based at least in part on a predefined preference. For example, the predefined preference may include: a preference of a user of the vehicle that includes the integrated circuit; a desired charging characteristic; or a range of the vehicle. Note that the dynamic power may be determined based at least in part on: an environmental condition (such as a temperature of a battery in a vehicle); or a distance of planned travel in the vehicle that includes the integrated circuit. Moreover, the dynamic power may be determined based at least in part on a subscription characteristic (such as a software-defined subscription characteristic, which may be defined or specified by a user).

Furthermore, the operations may include receiving usage information associated with the one or more nodes. Note that the one or more nodes may include multiple nodes, and the usage information may include a report of a problem associated with at least a second node in the multiple nodes.

Another embodiment provides the electronic device.

Another embodiment provides a vehicle that includes the integrated circuit.

Another embodiment provides a system that includes the integrated circuit.

Another embodiment provides a method for dynamically adjusting power of one or more nodes in a network. This method includes at least some of the operations performed by the integrated circuit.

In a second group of embodiments, a system is described. The system includes multiple networked devices communicably coupled in a network, where at least a subset of the networked devices supply power to a given electronic device. Moreover, the system includes a control device (such as a controller) communicably coupled in a network, where the control device supplies power information to the subset of the networked devices via the network.

Note that the control device supplies power to the given electronic device.

Moreover, the control device may include a gateway device coupled between the network and a vehicle bus. For example, the gateway device may include: a USB hub; or a wireless charger. In some embodiments, the gateway device may include a vehicle head unit.

Furthermore, the network may be directly coupled to a vehicle bus.

Additionally, a given networked device may be a USB charger or a wireless charger.

In some embodiments, the power information includes at least one of: a maximum power budget; a current power budget; or a power availability.

Note that the control device may: determine a maximum power budget, where the maximum power budget is a maximum power that can be supplied at a given time by the network devices; determine a current power budget, where the current power budget is an instantaneous power that is supplied by one or more of the network devices; determining a power availability; and communicating the power availability to at least one of the network devices.

Moreover, the control device may: determine a revised power availability in response to: a personal device being coupled to a network device, a personal device being disconnected from a network device, or a change maximum power budget; and communicate the revised power availability to at least one of the network devices.

Another embodiment provides an apparatus. This apparatus includes: multiple charging devices, where a given charging device is configured to supply power to a given personal device; and a controller in communication with the multiple charging devices, where the controller is configured to: determine a maximum power budget; determine a current power budget; determine a power availability; and communicate the determined power availability to a set of charging devices that are not currently supplying power to a given electronic device. Moreover, the apparatus may include a LIN bus coupled between the multiple charging devices and the controller.

Furthermore, the controller may determine the power availability based at least in part on a detection of an electronic device coupled to a given charging device.

Additionally, the controller may determine a maximum power budget based at least in part on a fixed power level.

Note that the controller may determine a maximum power budget based at least in part on a battery temperature of a vehicle.

In some embodiments, the controller may determine a maximum power budget based at least in part on a battery charge level of a vehicle.

Moreover, the controller may determine a maximum power budget based at least in part on an engine running state of the vehicle.

Furthermore, the apparatus may include at least one of: a USB hub, a USB charger, or a wireless charger coupled to the controller.

Additionally, the apparatus may include a display coupled to the controller. The display may display at least one of: the maximum power budget, the current power budget, the power availability, or a personal-device vendor. In some embodiments, the display may receive an input of a power limitation. The controller may limit a power delivered by a given charging device based at least in part on the received input.

Note that the charging devices may include at least one of: a USB port; or a wireless charger.

Moreover, the controller may calculate a revised maximum power budget based at least in part on a change in status.

Furthermore, the controller may: determine a power adjustment; and communicate the power adjustment to a given charging device.

Another embodiment provides a method, which may be performed by a system. During operation, the system provides electrical power to multiple charging devices. Then, a controller in the system: determines a maximum power budget (such as a maximum power for each of the charging devices or nodes); determines a current power budget; determines a power availability; and communicates the power availability to at least one of the charging devices.

Moreover, during operation, the system may: determine a revised power availability based at least in part on a detection of a new personal device coupled to a given charging device; and communicate the revised power availability to at least one of the charging devices. Note that the revised power availability may be determined based at least in part on a detection of a personal device being decoupled from a given charging device. Then, the system may communicate the revised power availability to at least one of the charging devices.

Furthermore, determining of a maximum power budget may be based at least in part on a fixed power level.

Additionally, determining of a maximum power budget may be based at least in part on a received maximum power level from a processor of a vehicle.

In some embodiments, the communicating is performed by a LIN bus coupled between the multiple charging devices and the controller.

During operation, the system may display, on a display, at least one of the maximum power budget, the current power budget, or the power availability.

Moreover, during operation, the system may receive: an input of a power limitation on the display, and limit a power delivered by a given charging device based at least in part on the received input.

Furthermore, during operation, the controller may calculate a revised maximum power budget based at least in part on a change in status of an engine of a vehicle (such as a battery charge in an electric vehicle).

Additionally, during operation, the controller may calculate a revised maximum power budget based at least in part on a change in temperature of a battery in a vehicle.

In some embodiments, during operation, the system may determine a power adjustment based at least in part on a signal (or input) from a personal device. Then, the system may communicate a power adjustment to a given charging device based at least in part on the signal.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

FIG. 1 is a drawing illustrating an example of a vehicle equipped with power-delivery chargers according to some embodiments of the present disclosure.

FIG. 2 is a block diagram illustrating an example of a power-delivery system according to some embodiments of the present disclosure.

FIG. 3 is a block diagram illustrating an example of a private Local Interconnected Network (LIN) bus according to some embodiments of the present disclosure.

FIG. 4 is a block diagram illustrating an example of an architecture or configuration of a private bus or network according to some embodiments of the present disclosure.

FIG. 5 is a block diagram illustrating an example of an architecture or configuration of a private bus or network according to some embodiments of the present disclosure.

FIG. 6 is a block diagram illustrating an example of an architecture or configuration of a public bus or network according to some embodiments of the present disclosure.

FIG. 7 is a flow diagram illustrating an example of a method for dynamically adjusting power of one or more nodes in a network according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

An integrated circuit is described. This integrated circuit may include (or be coupled to) an interface circuit that communicates with one or more nodes in a network. Moreover, the integrated circuit may include a control circuit (or control logic or a processor) that performs the operations of: receiving charging information associated with the one or more nodes; determining, based at least in part on the charging information, a dynamic power to be supplied to an electronic device by at least a first node in the one or more nodes; and providing, addressed to at least the first node, an instruction specifying or indicating the dynamic power of at least the first node at a given time.

By determining the dynamic power and providing the instruction, the circuit techniques may allow the network to be dynamically adapted to different conditions. For example, the circuit techniques may allow different nodes (or charging devices) in the network to have different maximum powers. Moreover, the circuit techniques may allow the dynamic power to be adapted based at least in part on the charging information of the one or more nodes. Furthermore, the circuit techniques may allow the dynamic power to be adapted based at least in part on an environmental condition, a length of a trip (or estimated travel distance), or a user preference (such as predefined user preference, Original Equipment Manufacturer or OEM preference, or a software-defined subscription characteristics). Consequently, by making the nodes or charging devices in the network more intelligent and flexible, the circuit techniques may improve the performance of the network as a function of different criteria. Therefore, the circuit techniques may increase adoption of the network in a variety of applications, such as automotive applications. Moreover, by improving the performance of the network, the circuit techniques may improve satisfaction of users of the network.

In the discussion that follows, a vehicle may include: an automobile, a sports utility vehicle, a truck, a bus, a motorcycle, a train, an aircraft, a boat, or another type of transportation conveyance. However, in the discussion that follows, an automobile is used as an illustrative example of the vehicle.

Moreover, in the discussion that follows, a vehicle may use one or more types of power-delivery chargers to provide electrical power at various locations throughout the vehicle. While a wide variety of types of power-delivery chargers may be used, in the discussion that follows USB chargers and wireless chargers (such as wireless chargers that operated based on the Qi wireless charging standard) are used as an illustrative example. The power-delivery chargers may be configured to provide power to electronic devices coupled to the power delivery chargers, and may be connected together by way of a bus. In some embodiments, a private bus, such as a LIN bus is used to communicate between the various power-delivery chargers. Furthermore, the bus may also be connected to a controller device, such as a USB hub, a head unit of a vehicle, or other electronic device that may communicate instructions and/or other data to the power-delivery chargers coupled to the bus. More generally, a wide variety of electrical components may be used in the vehicle, such as: an AC inverter, a generator, a transformer, a power supply (e.g., a switched-mode power supply), etc.

Furthermore, in the discussion that follows, the terms ‘approximately’ or ‘substantially’ mean that a value is expected to be close to a stated value. However, there may be minor variations that prevent the values from being exactly as stated. Consequently, anticipated variances, such as 10% differences, are reasonable variances that may occur and are known to be acceptable relative to a stated or ideal goal for one or more embodiments of the present disclosure. Additionally, the terms ‘first,’ ‘second,’ ‘next,’ ‘last,’ ‘before,’ ‘after,’ and other similar terms are used for description and ease of reference purposes only and are not intended to be limiting to any configuration of elements or sequences of operations for the various embodiments of the present disclosure. Note that the terms ‘coupled,’ ‘connected’ or otherwise are not intended to limit such interactions and communication of signals between two or more devices, systems, components or otherwise to direct interactions; indirect couplings and connections may also occur.

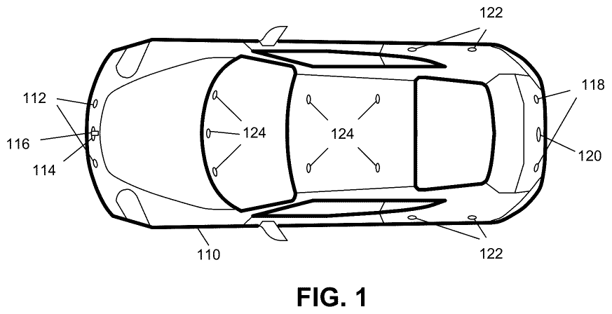

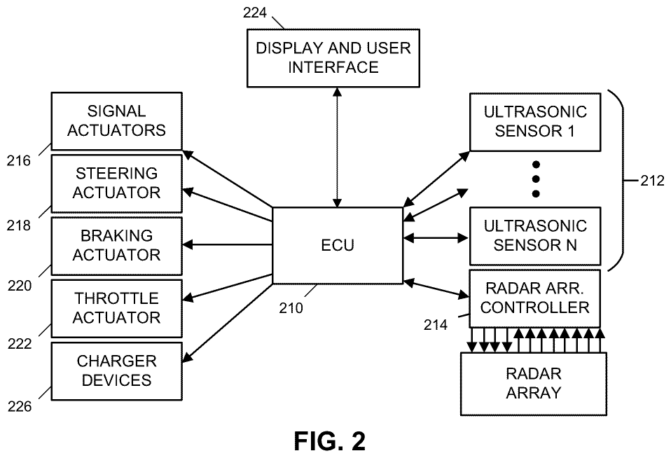

We now describe embodiments of the circuit techniques. FIG. 1 presents a drawing illustrating an example of a vehicle 110 equipped with an array of radar antennas, including: antennas 112 for short-range sensing (e.g., for parking assist), antennas 114 for mid-range sensing (e.g., for monitoring stop-and-go traffic and cut-in events), antennas 116 for long-range sensing (e.g., for adaptive cruise control and collision warning), each of which may be placed behind the front bumper cover. Antennas 118 for short-range sensing (e.g., for back-up assist) and antennas 120 for mid-range sensing (e.g., for rear-collision warning) may be placed behind the back-bumper cover. Moreover, antennas 122 for short-range sensing (e.g., for blind-spot monitoring and side-obstacle detection) may be placed behind the car fenders. Each antenna and each set of antennas may be grouped in one or more arrays. Furthermore, each array may be controlled by a radar-array controller 205 (FIG. 2). The type, number, and configuration of sensors in the sensor arrangement for vehicles having driver-assist and self-driving features varies. The vehicle may employ the sensor arrangement for detecting and measuring distances/directions to objects in the various detection zones to enable the vehicle to navigate while avoiding other vehicles and obstacles. While the preceding discussion illustrates vehicle 110 with radar sensors, in other embodiments vehicle 110 may include additional types of sensors, such as LiDAR, an ultrasonic sensor, a camera, etc.

Moreover, vehicle 110 may include charger devices 124 (such as USB or wireless chargers) at the passenger seat, on the dashboard, the rear console locations and/or the rear seat locations. In other examples, the charger devices may be placed at other locations, such as in the trunk, of the vehicle. The locations of the charging devices shown in FIG. 1 are presented as one possible example of an arrangement of charging devices.

FIG. 2 presents a block diagram illustrating an example of a driver-assistance system and a charging system. This driver assistance system may include an electronic control unit (ECU) 210 coupled to various sensors 212 and radar-array controller 214 as the center of a star topology. However, other topologies may include serial, parallel, and hierarchical (tree) topologies.

Radar-array controller 214 may couple, radio-frequency (RF) frontends, to the transmit and receive antennas (e.g., in antennas 114) to transmit electromagnetic waves, receive reflections, and determine a spatial relationship of the vehicle to its surroundings. Moreover, radar-array controller 214 may couple to carrier-signal generators. In some embodiments, radar-array controller 214 may control the timing and order of actuation of a plurality of carrier signal generators.

In order to provide automated parking assistance, ECU 210 may couple to a set of actuators, such as: a turn-signal actuator 216, a steering actuator 218, a braking actuator 220 and/or a throttle actuator 222. Moreover, ECU 210 may couple to an interactive user interface 224 to accept user input and to display various measurements and system status. In some examples, ECU 210 may be coupled to a data bus of the vehicle. The data bus is configured to enable ECU 210 to communicate with the various modules and/or sensors coupled to ECU 210.

Using user interface 224, sensors, and actuators, ECU 210 may provide: automated parking, assisted parking, lane-change assistance, obstacle and blind-spot detection, autonomous driving and/or other desirable features. During operation of vehicle 110 (FIG. 1), sensor measurements may be acquired by ECU 210, and may be used by ECU 210 to determine a status of vehicle 110. Moreover, ECU 210 may act on the status and incoming information to actuate signaling and control transducers to adjust and maintain operation of vehicle 110. For example, the operations that may be provided by ECU 210 include driver-assist features, such as: automatic parking, lane following, automatic braking, self-driving, etc.

Furthermore, in order to obtain the measurements, ECU 210 may employ a MIMO radar system. Radar systems operate by emitting electromagnetic waves that travel outward from a transmit antenna before being reflected towards a receive antenna. The reflector may be any moderately reflective object in the path of the emitted electromagnetic waves. By measuring the travel time of the electromagnetic waves from the transmit antenna to the reflector and back to the receive antenna, the radar system may determine the distance to the reflector. Additionally, by measuring a Doppler shift of the electromagnetic waves, the radar system may determine a velocity of the reflector relative to vehicle 110 (FIG. 1). When multiple transmit or receive antennas are used, or when multiple measurements are made at different positions, the radar system may determine the direction to the reflector and, thus, may track the location of the reflector relative to vehicle 110 (FIG. 1). With more sophisticated processing, multiple reflectors may be tracked. In some embodiments, the radar system may employ array processing to ‘scan’ a directional beam of electromagnetic waves and to construct an image of the surroundings of environment around vehicle 110 (FIG. 1). In general, pulsed and/or continuous-wave implementations of the radar system may be implemented.

Additionally, ECU 210 may be connected or coupled to charger devices 226, such as USB or wireless chargers located in the passenger compartment of a vehicle.

We now further describe the circuit techniques. As noted previously, charging solutions are becoming more pervasive throughout vehicles. In the future, it will not be uncommon to have a vehicle that includes multiple charging devices throughout the vehicle. In some examples, the vehicle may include at least a wireless charger and/or a wired charging device (either of which is sometimes referred to as a ‘charging device’) for some or all of the passenger seats in the vehicle. In some examples, the wired charging device may include a USB port configured for charging. In other examples, the wired charging device may be other forms of wired charging. The vehicle may also include additional wireless chargers, USB ports and/or other wireless chargers in a trunk area, footwell, dashboard, rear console, or other non-seat associated positions as well. These chargers may be used by occupants of the vehicle to charge/operate personal electronic devices or to charge/operate other electronic devices. Additionally, these chargers or charging devices may be used to charge other vehicle accessories or electronic devices. In the present disclosure, the term ‘personal device’ means an electronic device that is being supplied power or is electrically coupled to one of the chargers. Moreover, in some examples, the charging devices may also include power-supplying devices such as an AC converter, configured to supply a higher voltage than the voltage provided by the wired charging device. The AC converter may include a traditional power plug that would be found in a home and be configured to supply 120 or 220 volts through the power plug. The present system may be able to control and/or limit power provided from the AC converter that is coupled to the charging network.

The USB specification for Power Delivery (PD) 3.1 includes charging rates up to 240 Watts (48 Volts at 5 Amps) per USB-C port. Thus, the power requirements for a charging system to deliver the maximum power to each charging port in a vehicle can easily be on the order of several hundred Watts. The electronic devices supplying power (e.g., chargers) may be referred to as ‘source devices’ and those receiving power (e.g., personal devices) may be referred to as ‘sink devices.’

Depending on the electrical system in a given vehicle, the theoretical maximum power delivered by all of the possible charging devices may exceed the power that the electrical system in the vehicle can provide at any given time. Furthermore, the amount of power a vehicle can deliver over time may change. For example, in ambient cold temperatures, an electric vehicle may be able to provide less power than the same vehicle when the ambient temperature is warm. Similarly, a gas-powered car may be able to deliver more power while the engine is running than when the engine is off.

In the disclosed integrated circuit techniques, a control system or control logic (such as an integrated circuit or a component, subcircuit or module in the integrated circuit, e.g., a control circuit or software executed by a processor in the integrated circuit) may determine: how much power is available to a device-charging system, how much power is currently used by a device-charging system, and/or how much power a new electronic device connected to the device-charging system will use. In some examples, the control system may not make all of these determinations. For example, in some embodiments, a maximum power availability may be a predefined or fixed value (such as 100 W). In other embodiments, the control system may be one of the electronic devices on a bus or a network. In the present disclosure, a ‘bus’ is an electrical pathway (such as a wire or a connector) with one or more nodes (such as charging devices and, more generally, devices), and the bus conveys electrical power and/or data or information. Moreover, in the present disclosure, a ‘network’ is an interconnected group of nodes (such as charging devices and, more generally, devices) that conveys electrical power and/or data or information. The coupling between components in a bus or a network may be direct (e.g., wired) or indirect (e.g., wireless). In the present disclosure, a bus is understood to be a particular type of network. Moreover, in the present disclosure, the circuits techniques are applied to a bus and/or a network, and a ‘bus’ or a ‘network’ should be understood to be interchangeable terminology. Note that the bus or the network may be used to charge or operate a wide variety of electronic devices (such as a consumer convenience charging device and/or a power providing device) that is not essential to the vehicle operation and, therefore, which may have or may provide a variable amount of power.

In other examples, the bus or network may be a standalone network in which electronic devices of the network can communicate with each other without the use of a control system. The electronic devices may share information such as: the presence or lack of presence of a connected electronic device; the instantaneous power use of a connected electronic device; the available power levels that are possible for a connected electronic device; data related to a connected electronic device (such as an electronic-device identifier); and/or other information that may be communicated. Additionally, one or more of the electronic devices of the bus or network may be in communication with other systems of the vehicle. For example, the electronic device(s) may communicate with the vehicle to: receive instructions; provide diagnostic information; and/or communicate other information.

Note that information may be shared within devices in a network or on a bus, either between the charging devices themselves or with a controlling device (such as a control system or control logic). The information shared may include: a delivered (e.g., instantaneous) charging power; a contracted charging power; a maximum charging power for a given electronic device coupled to a charger; a device temperature; and/or either the charging device or the electronic device coupled to the charger, and a battery voltage of the electronic device coupled to the charger. (In the present disclosure, note that a connection or coupling may include DC electrical coupling or AC electrical coupling.) Additionally, in some embodiments other information may be shared as well, e.g., a maximum battery capacity of an electronic device coupled to a charger and an approximate remaining charging time. In some examples, personal devices may share electronic-device vendor information with the charger.

Each of the charging devices (e.g., wireless chargers, USB ports, and USB hubs) may be electrically coupled or connected to both a power source and a data bus (e.g., a network). In some embodiments, the power source may be a voltage (e.g., 12 V) directly provided by one or more batteries of the vehicle. For example, the given charging device may convert the vehicle battery voltage to a voltage provided by the given charging device. In some examples, the data bus may allow each charging device to communicate with the control system or control logic. The charging device may communicate an amount of power it is currently consuming and/or an amount of power currently being supplied to a charging device to the control system or control logic. Additionally, the control system or control logic may communicate the maximum power available to each of the charging devices based at least in part on an available amount of power. In some instances, the control system or control logic may communicate a power adjustment to a given charging device. A power adjustment may indicate to the given charging device an increase or decrease in the amount of power that the charging device can provide to an electronic device electrically coupled or connected to the charging device. In some examples, the data bus may be a LIN bus. In other examples, the bus or network may be a USB bus, another type of electrical bus, an optical bus, or another data bus. The power source for each charging device may be a direct electrical connection to a voltage source of the vehicle. However, in other embodiments, the connection to a power source of the vehicle may be indirect (such as AC coupling). In other examples, the power source may be a USB bus that also functions as the data bus. In some examples, the various devices of the system may include firmware and/or software that can be flashed (e.g., updated) by way of firmware or software being communicated over the bus. Moreover, in some examples, the vehicle may have a processor that functions as a master processor for some (such as a subset) or all of vehicle systems, e.g., ECU 210 (FIG. 2). This processor may be able to communicate instructions to control some or all of the functionality of the charging system or control logic. For example, some of the processing and/or determinations may be made by the processor in the vehicle and communicated to the charging system or control logic.

The control system or control logic may take the form of: a USB hub, a head unit of the vehicle, a dedicated control device, one of the electronic devices coupled or connected to the network or the bus, and/or all of the devices may perform control functions together. Thus, at least some of the operations in the circuit techniques may be performed in a centralized or in a distributed manner. In some examples, the controller or control logic may be a combination of a head unit and USB hub. The control system or control logic may be in communication with the head unit by way of a USB bus, such as a USB 2.0, USB 3.0, or other USB bus. In some examples, the head unit may include a display, such as a display of an infotainment system of a vehicle (e.g., the display and user interface 224 in FIG. 2). The display may show or display various parameters of the charging system. In some examples, the display may show a given power budget for the USB system and/or power usage of the various charging devices of the system. In some further examples, the display may also be able to show a device identification for each of the electronic devices coupled to the charging system. The display may also show a position in the vehicle where each of the electronic devices is coupled or connected to the charging system. In yet another example, the display may provide controls to limit and/or adjust the power supplied to a given charging device or electronic device connected or coupled to a charging device. Additionally, the display may enable a person in the vehicle to control various parameters of the electronic devices connected to the network or the bus. For example, via the display (such as a touch-sensitive display or a human-interface system, such as a keyboard, a mouse, a voice-recognition system, etc.), a user may be able to set charging configurations. Note that one may configure a charging port to be always on instead of switching off when the vehicle is turned off. In another example, a user may be able to set a charging priority, such as making sure a cellular telephone of a driver receives the maximum charging power it requests. In another example, a charging priority may be set that all connected devices receive at least the minimum power level to operate the devices. This may be beneficial in situations where a power level required to charge all of the devices would exceed the maximum power output of the charging system, thus, the system controls the delivered power to both ensure all devices are operational (even if they aren't charging) but not exceed the maximum power of the system. In some other examples, the display may also be able to display vendor information of personal devices that are connected to chargers or charging devices. Thus, from the display one can tell which personal devices are connected or coupled to given chargers in a vehicle.

In some embodiments, the disclosed system may include a private bus. A private bus is a bus that does not communicate with any electronic devices that are not part of the disclosed system (e.g., electronic devices on the private bus may only communicate with other electronic devices connected or coupled to the charging-system bus). In this example, the vehicle may have a primary bus that is in communication with modules throughout the vehicle, such as window controllers, radar sensors, camera sensor, etc. The charging system may have a charging-system bus (i.e., a private bus or private network) that is not in communication with the primary bus. In some examples, the controller or control logic circuit of the charging system may be coupled to both the charging-system bus and the primary bus. In other examples, the bus may be a bus that includes more devices than those described with respect to the charging system. In some embodiments, the private bus may support from one to sixteen (or more) client devices. Additionally, the private bus may allow electronic devices coupled or connected to the bus to communicate with each other. For example, in some modes the controller or control logic may be a master charging device in communication with the other charging devices.

In some embodiments, the system may be able to determine a fault or problem in the charging system and/or provide usage statistics. The system may determine the fault or problem based on a charging device reporting information to the system. In some examples, the fault may be a non-functioning charging device. In other examples, the fault may be: a short circuit within a charging device, an over-current fault, an overheating fault, etc. Other faults may include a charging device not responding to a communication signal from the controller. In one example, a fault-detection routine may be performed as a diagnostic operation during vehicle assembly. This diagnostic operation may ensure that chargers are connected correctly and able to supply power to personal devices before a vehicle is delivered to a customer. Usage statistics may include instantaneous power use of a connected device and/or the available power levels that are possible for a connected device. In some examples, based at least in part on the usage statics, the control system, control logic or another network device may adjust the power delivered to a given electronic device being charged by the network. In some instances, the usage statistics may include: the number charging hours; the number and/or type of personal devices charged; the given charging power delivered to electronic devices, etc. The usage statistics may be recorded and reported on a per-trip basis and/or be recorded and reported on an aggregate basis.

Additionally, diagnostic information from the bus or the network may be used for vehicle fleet management, customer service, marketing, repair and servicing, subscription services, etc. In another example, the system may be able to perform diagnostic testing each time the vehicle is started (or powered on). This diagnostic test may determine if each charger or charging device is functioning correctly each time the vehicle is used. When a fault is a detected, the given charger or charging device with the fault may be disabled and an alert may be provided to a vehicle operator of the fault. Additionally, faults may be detected and/or reported while the vehicle and chargers or charging devices are in use. In another example, a fleet manager may be able to set and or remotely control the charging system. For example, the fleet manager may be able to remotely enable or disable the charging system.

In yet some examples, the vehicle of which the present disclosure is a part, may include a wireless communication system. The wireless communication system may be a part of or in communication with the head unit. In another examples, the wireless communication system may also be in communication with the bus of the disclosed system. The wireless communication system may be able to communicate data from the devices of the bus or the network to a mobile device, computing device, or vehicle key associated with the vehicle. A user may be able to determine device-charging status, whether a device is connected or coupled to a charger, or other information related to the device(s) of the bus. In some examples, the device may communicate various power levels of the device. For example, the device may communicate a minimum power level to charge the device and/or a minimum power level to operate the device. When the present system makes determinations about the power levels to communicate to respective charging devices, it may use these power levels as part of the determination. In another example, an alert may be sent when an electronic device is still coupled to a charging device when the vehicle is turned off, after a period after the vehicle is turned off, or after a mobile device (such as a cellular telephone or a mote) moves away from the vehicle. This alert may prevent an electronic device from being left in the vehicle while connected or coupled to a charging device. The wireless communication may be performed using Bluetooth®, an Institute of Electrical and Electronics Engineers (IEEE) 802.11 compatible protocol, or any other wireless protocol.

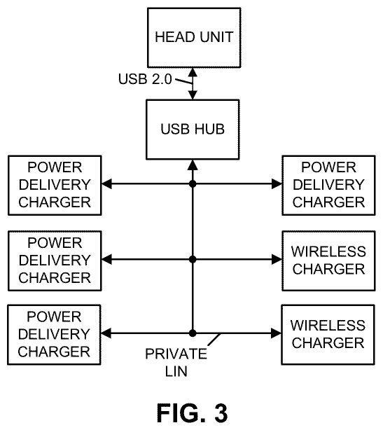

FIG. 3 presents a block diagram illustrating an example of a private bus. In this example, the private bus may be a LIN bus. In this example, four USB PD chargers and two Wireless Chargers are coupled to a USB Hub by way of a Private LIN bus. The USB Hub is in communication with a Head Unit of a vehicle by way of a USB 2.0 connection. As previously discussed, the private LIN bus may enable the four USB PD chargers and the two Wireless Chargers to communicate with each other and the USB hub. Note that FIG. 3 is one example of a layout for use with the present disclosure.

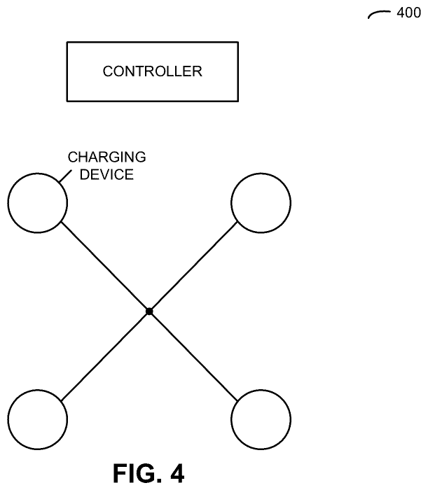

FIG. 4 presents a block diagram illustrating an example of an architecture or configuration of a private bus. Notably, network 400 of FIG. 4 shows a standalone network. As this network is not directly connected or coupled to a vehicle bus, it may be considered a private network. A private network is one in which electrical signals of the bus or the network are only communicated between devices of the network. In a standalone network, the devices in the network may share information and manage charging collectively and automatically. In some embodiments, the nodes (such as a given charging device) of the standalone network may each report their charging needs or current charging abilities to the other nodes. When needed, the nodes may responsively change the power that a given node can deliver to an electronic device connected or coupled to that node. Network 400 is sometimes referred to as a ‘peer-to-peer network’ and each device may be able to communicate and negotiate the power supplied with the other devices of the network. The private bus of FIG. 4 may include a wired or wireless connection between one or more of the charging devices and the controller. In some examples, the controller may include a wired or wireless connection with a bus of the vehicle. Thus, the controller may directly communicate with a charging device of the private network to control the operation of the charging devices of the private network.

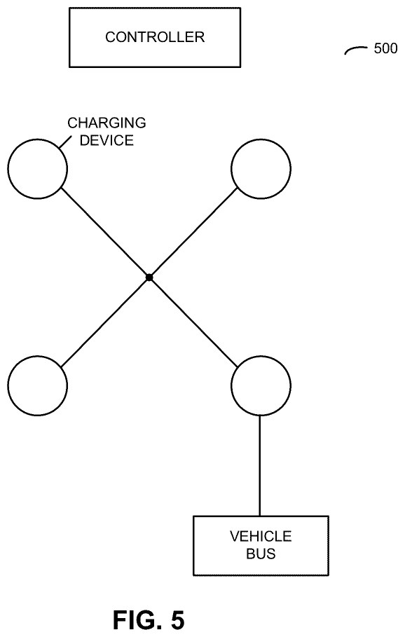

FIG. 5 presents a block diagram illustrating an example of an architecture or configuration of a private bus or network. Notably, network 500 of FIG. 5 shows a network of nodes, where one node is communication with a vehicle bus. In some examples, the node in communication with a vehicle bus may be: a head unit of the vehicle; a USB hub of the vehicle; and/or one of the chargers (or charging devices) of the network. Because network 500 is connected or coupled to a vehicle bus, the vehicle (or a user of the vehicle) may be able to: configure aspects of network 500; receive diagnostic information from network 500; and/or receive usage information from network 500. Because network 500 is not directly connected or coupled to the vehicle bus, network 500 may also be considered a private network as electrical signals sent on network 500 may only be sent to network nodes, with one of the nodes acting as an interface to the bus of the vehicle (or another communication system of the vehicle). The private bus of FIG. 5 may include a wired or wireless connection between one or more of the charging devices and the controller. In some examples, the controller may include a wired or wireless connection with a bus of the vehicle. Thus, the controller may communicate with a charging device of the private network by way of the vehicle bus coupled to one or more of the charging devices to control the operation of the charging devices of the private network.

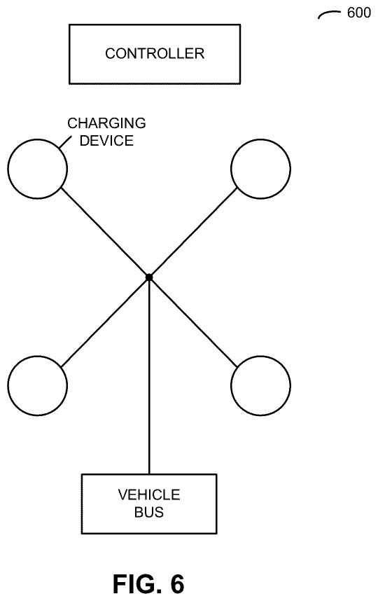

FIG. 6 presents a block diagram illustrating an example of an architecture or configuration of a public bus or network. Notably, network 600 of FIG. 6 shows a network of nodes, where the bus or the network of the nodes is directly in communication with a vehicle bus. This type of network is a public (e.g., not a private) network as the signals communicated between nodes are also on the vehicle's bus. While this style of network may be used with the present disclosure, it may be desirable to use a private network rather than a public network. A public network may have more stringent cyber security requirements than a private network. Additionally, a public network may have messaging specifications defined by the network. Thus, a public network may limit the messaging flexibility between charging nodes of the network because of the messaging characteristics of the public network. The public bus of FIG. 6 may include a wired or wireless connection between one or more of the charging devices and the controller. In some examples, the controller may include a wired or wireless connection with a bus of the vehicle. Thus, the controller may communicate with the charging devices of the public network by way of the vehicle bus coupled to the public network to control the operation of the charging devices.

While FIGS. 4-6 illustrate the controller as being separate from the network nodes, in other embodiments the controller may be implemented in one or more of the network nodes.

In some embodiments, the integrated circuit, the network or the bus may include fewer or additional components, positions of one or more components may be changed, two or more components may be combined into a single component, and/or a single component may be divided into two or more components.

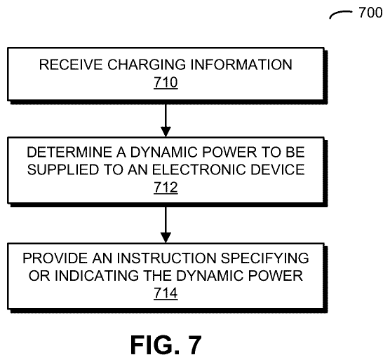

We now describe embodiments of a method. FIG. 7 presents a flow diagram illustrating an example of a method 700 for dynamically adjusting power of one or more nodes in a network using an integrated circuit, such as integrated circuit in a USB hub or a head unit in FIG. 3. During operation, the integrated circuit may receive charging information (operation 710) associated with one or more nodes in a network. Then, the integrated circuit may determine, based at least in part on the charging information, a dynamic (as a function of time) power to be supplied (operation 712) to an electronic device by at least a first node (or charging device) in the one or more nodes. Next, the integrated circuit may provide, addressed to at least the first node, an instruction (operation 714) specifying or indicating the dynamic power.

In some embodiments of the method 700, there may be additional or fewer operations. Moreover, the order of the operations may be changed, and/or two or more operations may be combined into a single operation. In some examples, rather than determining a dynamic power, the system may determine an adjusted power (i.e., a power level different from the default power level) at operation 712 and communicate the adjusted power to the first node at operation 714.

For example, method 700 may include an initial condition where each charging device is configured to deliver a predetermined amount of power. When a device is coupled to a respective charging device of the system, the system may responsively provide an amount of power up to the predetermined amount of power. They system may also receive a maximum possible charging power from the device when it is coupled. In some examples, the system may only provide the instruction at operation 714 if the maximum power level for the device exceeds the predetermined amount of power provided by the respective charging device.

In another example, method 700 may include an initial condition where each charging device is configured to deliver a predetermined amount of power and the system has a maximum total charging power. In some examples, the system may only provide the instruction at operation 714 if the power level of the devices coupled to the charging devices would exceed the maximum total charging power.

In some yet further examples, at operation 712, the determined power may not be a dynamic power. The power determined at operation 712 may be a static power that updates the power level that may be supplied by a given charger.

In other examples, method 700 may perform some of the other functions and make some of the other determinations as disclosed herein. Additionally, method 700 (or a subset of method 700) may be performed periodically, such as every minute while the vehicle power is turned or. In other examples, method 700 (or a subset of method 700) may be performed in response to a change in the charging system, such as a new device is connected, a charging device is disconnected, a charger reports a fault, a device reports a full charge, or a charging speed to a device is reduced (such as when a device is fully charged), among other possible reasons the system may perform method 700.

The disclosed integrated circuit and the circuit techniques can be (or can be included in) any electronic device or system. For example, the electronic device may include: a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-electronic device, an access point, a router, a switch, communication equipment, test equipment, a vehicle, a ship, an airplane, a car, a truck, a bus, a motorcycle, manufacturing equipment, farm equipment, construction equipment, or another type of electronic device.

Although specific components are used to describe the embodiments of the integrated circuit and/or the integrated circuit that includes the integrated circuit, in alternative embodiments different components and/or subsystems may be present in the integrated circuit and/or the integrated circuit that includes the integrated circuit. Thus, the embodiments of the integrated circuit and/or the integrated circuit that includes the integrated circuit may include fewer components, additional components, different components, two or more components may be combined into a single component, a single component may be separated into two or more components, one or more positions of one or more components may be changed, and/or there may be different types of components.

Moreover, the circuits and components in the embodiments of the integrated circuit and/or the integrated circuit that includes the integrated circuit may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar. Note that electrical coupling or connections in the preceding embodiments may be direct or indirect. In the preceding embodiments, a single line corresponding to a route may indicate one or more single lines or routes.

As noted previously, an integrated circuit may implement some or all of the functionality of the circuit techniques. This integrated circuit may include hardware and/or software mechanisms that are used for implementing functionality associated with the circuit techniques.

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the circuit techniques may be implemented using program instructions that are executed by a processor or in firmware in an integrated circuit.

Moreover, while examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An integrated circuit, comprising:
an interface circuit configured to communicate with one or more nodes in a network; and
a control circuit configured to perform operations of:
receiving charging information associated with the one or more nodes;
determining, based at least in part on the charging information, a dynamic power to be supplied to an electronic device by at least a first node in the one or more nodes; and
providing, addressed to at least the first node, an instruction specifying or indicating the dynamic power of at least the first node at a given time.

2. The integrated circuit of claim 1, wherein the network comprises a bus.

3. The integrated circuit of claim 1, wherein the bus comprises: a local interconnected network (LIN) bus; a Universal Serial Bus (USB); a Control Area Network (CAN) bus; an Ethernet bus; or a wireless bus.

4. The integrated circuit of claim 1, wherein the electronic device is electrically or wirelessly coupled to the first node.

5. The integrated circuit of claim 1, wherein the one or more nodes comprise charging devices.

6. The integrated circuit of claim 1, wherein the one or more nodes comprise multiple nodes, and the integrated circuit is included in a second node in the multiple nodes.

7. The integrated circuit of claim 1, wherein the one or more nodes comprise multiple nodes, and the integrated circuit is separate from the one or more nodes.

8. wherein the one or more nodes comprise multiple nodes, and the integrated circuit.

9. The integrated circuit of claim 1, wherein the integrated circuit comprises a controller for the one or more nodes.

10. The integrated circuit of claim 1, wherein the integrated circuit comprises: a Universal Serial Bus (USB) hub; or a head unit for the network.

11. The integrated circuit of claim 1, wherein the one or more nodes comprise multiple nodes, the instruction indicates that at least the first node is to supply a different power from at least a second node in the multiple nodes.

12. The integrated circuit of claim 1, wherein the charging information indicates: an identifier of the electronic device; or a type of the electronic device.

13. The integrated circuit of claim 1, wherein the instruction indicates a maximum power supplied by at least the first node.

14. The integrated circuit of claim 1, wherein the integrated circuit is included in a vehicle, and the maximum power is different from a maximum power available in the vehicle.

15. The integrated circuit of claim 1, wherein the one or more nodes comprise multiple nodes, and the dynamic power is determined based at least in part on power supplied by the multiple nodes.

16. The integrated circuit of claim 1, wherein the dynamic power is determined based at least in part on a predefined preference.

17. The integrated circuit of claim 16, wherein the predefined preference comprises: a preference of a user of a vehicle that includes the integrated circuit; a desired charging characteristic; or a range of the vehicle.

18. The integrated circuit of claim 16, wherein the dynamic power is determined based at least in part on: an environmental condition; a distance of planned travel in a vehicle that includes the integrated circuit; or a software-defined subscription characteristic.

19. A system, comprising:
an integrated circuit, comprising:
an interface circuit configured to communicate with one or more nodes in a network; and
a control circuit configured to perform operations of:
receiving charging information associated with the one or more nodes;
determining, based at least in part on the charging information, a dynamic power to be supplied to an electronic device by at least a first node in the one or more nodes; and
providing, addressed to at least the first node, an instruction specifying or indicating the dynamic power of at least the first node at a given time.

20. A method for dynamically adjusting power provided by one or more nodes in a network, comprising:
by an integrated circuit:
receiving charging information associated with the one or more nodes;
determining, based at least in part on the charging information, a dynamic power to be supplied to an electronic device by at least a first node in the one or more nodes; and
providing, addressed to at least the first node, an instruction specifying or indicating the dynamic power of at least the first node at a given time.
